(19) United States
(12) Patent Application Publication
(10) Pub. No.: US 2005/0237177 A1
(43) Pub. Date: Oct. 27, 2005

(54) Signal linked smoke / fire detector

(76) Inventor: Joseph Michael Savage, Philadelphia, PA (US)

Correspondence Address: Joseph M. Savage, 501 Selma Street, Philadelphia, PA, 19116, US

(21) Appl. No.: 10/819,795

(22) Filed: Apr. 8, 2004

(51) Int. Cl. G08B 29/00

(52) U.S. Cl. 340/506; 340/628

(57) ABSTRACT

The signal linked detector is capable of activating all detectors in a system through The transmission of a radio frequency signal. It eliminates the need for detectors to be Inter-connected by wiring.

### CROSS REFERING APPLICATIONS

Not applicable

### BACKGROUND OF INVENTION

This device is to be used as an aid in Fire and Smoke Detection in residential and commercial Buildings.

There is currently not available a device which relays the detection of smoke and or fire without being inter-connected with “Hard Wiring”.

### SUMMARY

This device will allow any detector in a system to alert all other detectors without the need of a connecting wire(s).

### DETAILED DESCRIPTION

This device differs from existing ones in its ability to emit a signal to other detectors in the system through the transmission of a radio signal. This is accomplished by having transmitting and receiving capabilities. Any number of individual units (Detectors) in a given system will be set with matching codes that allow the signal receiving/transmitting to be confined to those units with the same settings. Upon detection of smoke/and or fire any one unit will transmit a signal to all other units with the same code setting, alerting occupants. Individually coding the units at installation will prevent the signal emitted from being received by units outside the system. This device will be powered by battery, hard wiring, or a combination of both.

Installation of these units will be considerably less costly than similar detectors which must be inter connected by wiring, most notably in existing buildings.

1. What I claim as my invention is the ability of the Signal—Linked Smoke and Fire Detector To activate all units in a given system without a need for connecting wires. (3)
